(19) United States
(12) Patent Application Publication
(10) Pub. No.: US 2018/0141479 A1
(43) Pub. Date: May 24, 2018

(54) TRUCK BED RAIL TIE DOWN ATTACHMENT

(71) Applicant: HORIZON GLOBAL AMERICAS INC., Plymouth, MI (US)

(72) Inventor: Derek Anderson, Newbury, OH (US)

(21) Appl. No.: 15/576,305

(22) PCT Filed: May 23, 2016
(86) PCT No.: PCT/US16/33732

§ 371 Date: Nov. 22, 2017

Related U.S. Application Data
(60) Provisional application No. 62/165,309, filed on May 22, 2015.

(51) Int. Cl. B60P 7/08

(52) U.S. Cl. CPC B60P 7/083

(57) ABSTRACT

Disclosed is a tie down attachment device configured to be selectively attached to a truck bed rail and support a strap thereon for adjustable support of cargo within the truck bed. The tie down attachment device may include a tie down mechanism, a strap received in the tie down mechanism, and an arm movably attached to the tie down mechanism securing the strap relative to the tie down mechanism. The tie down attachment may also include a clamp body attached to the tie down mechanism, the clamp body with a configuration to selectively and operatively engage a rail of a load bed of a vehicle.

### CROSS-REFERENCE RELATED APPLICATIONS

This application claims priority to U.S. Patent Application No. 62/165,309, filed May 22, 2015 and entitled “Truck Bed Rail Tie Down Attachment” which is incorporated by reference.

### TECHNICAL FIELD

The present invention is generally related to a tie down attachment device and, more particularly, to a tie down attachment device attachable to a rail of a truck bed.

### BACKGROUND

Various types of tie down devices are used to secure an object to a vehicle and in particular within a truck bed or other cargo carrying area. Such devices may generally be attached at one end to the object to be secured and at an opposite end to a fixed positon, such as on the vehicle. Alternatively, these devices may be attached at two fixed reference points contacting an object therebetween, such as on the vehicle. There are a number of available uses for such devices. Traditional tie down devices often utilize a strap, such as a rope or a vinyl band, to hold the object. Elastic or stretchable chords however, may also be used to provide flexibility in the length of the tie down device.

It is conventional in the hauling and transporting industry to utilize straps to tie down cargo being transported on truck beds or similar vehicles. Typically, one end of the strap(s) is secured in place on one side of the truck bed. The strap is then disposed over the cargo and the opposite end of the strap is inserted into a winch located on the opposite side of the truck bed. The winch is then rotated in a direction to tighten the strap and secure the cargo. This procedure is followed for each strap used in the arrangement, as there may be more than one strap and winch device.

Older disclosures depict devices that include tie-down strap winches. For example, U.S. Pat. No. 5,961,263, discloses a tie-down system for a truck bed that is capable of adjusting the position of a winch device along a track/channel system positioned along the truck bed. U.S. Pat. Nos. 6,846,140, 5,259,711, and 3,643,973 disclose a tie-down system for a truck bed that is capable of adjusting the position of fasteners along a track positioned along the truck bed. These embodiments have been known to employ a channel system that is required to be installed along the vehicle or truck bed to allow a protrusion to extend from the winch device or other fasteners to be positioned within the track/channel system and allow a user to slide the winch device or fastener within the channel. The winch device or fastener may be secured in a desired place along the channel for adjustable positioning of the strap across the cargo. However, this type of system requires additional support structures to be attached to the vehicle for the capability of adjusting the position of the winch device or fasteners. This requires additional space along the truck bed or vehicle and increases costs. Additionally, U.S. Pat. No. 7,909,553 discloses a tie-down system for a truck bed that places winch devices at along the interior side panels of a truck bed and cannot be adjusted.

However, these types of systems have been developed and may suffer from design deficiencies. For example, these designs may increase the overall cost and further complicate the process of adjusting and tightening the straps over the cargo within the truck bed. They may require the user to purchase extra equipment to properly use the tie-down device. Additionally, some of these designs fail to be sufficiently adjustable to provide sufficient support with minimal amount of effort from the user. Further, these designs may not be capable of supporting a significant cargo load capacity and may be subject to failure.

Therefore, it may be desirable to provide an adjustable truck bed tie-down attachment assembly and system that may be directly attached to the existing rail of a truck bed to permit a wider range of functionality, as well as reduce the need for additional structural tracks or channels to be installed along the truck bed or vehicle. It may also be desirable to provide a method for securing the tie-down to the truck to allow the user the freedom to place the tie down at a wider range of locations along the truck bed rail.

### SUMMARY

Disclosed is a tie down attachment device that may selectively attach to a truck bed rail and support a strap thereon for adjustable support of cargo within the truck bed. The tie down attachment device may include a tie down mechanism receiving the strap having first and second ends, the strap being moveable relative to the tie down mechanism. An arm may be movably attached to the tie down mechanism for securing the strap relative to the tie down mechanism. A clamp body may be attached to the tie down mechanism. The clamp body may selectively attach to the rail of a truck bed and may be adjustably positioned along a desired position of the rail. The tie down mechanism may be a ratchet having a housing wherein the strap may be wound and unwound from the housing. In one embodiment, the tie down mechanism may include a cam-buckle wherein the strap may be manually moveable relative to the tie down mechanism.

The ratchet may include a main body portion having a first end and an opposite second end and a base that extends between the first end and the second end wherein the base may be attached to the clamp body. The arm may be a lever arm that includes a locking member selectively engaged to at least one of the housing and the strap to prevent the strap from moving in the second direction. The lever arm may be rotatably attached to the main body portion of the ratchet.

The clamp body may include a top arm, a bottom arm and a base formed into a general C-shape. The clamp body may be formed of a monolithic piece of material such as aluminum. The clamp body may include an inner surface spaced from an outer surface and a plurality of chord members that extend between the inner surface and the outer surface. The clamp body may also include a clamp member that extends through the bottom arm and being attached to a clamp head wherein the clamp head may be configured to translate between the top arm in a closed position and the bottom arm in an open position.

In an embodiment, provided is a tie down attachment device that includes a tie down mechanism, a strap received in the tie down mechanism, an arm movably attached to the tie down mechanism securing the strap relative to the tie down mechanism, and a clamp body attached to the tie down mechanism. The clamp body having a configuration to selectively and operatively engage a rail of a load bed of a vehicle.

The tie down mechanism may comprise a ratchet. The ratchet may include a housing where the strap is wound and unwound from the housing. The arm may include a locking member selectively engaged to at least one of the housing and the strap to prevent the strap from moving away from the housing. The ratchet may include a main body portion having a first end and an opposite second end and a base that extends between the first end and the second end where the base is attached to the clamp body.

The tie down mechanism may include a cam buckle where the strap is manually moved relative to the tie down mechanism. The clamp body may include a top arm, a bottom arm and a base formed into a general C-shape. The clamp body may be formed of a monolithic piece of material. The clamp body may include an inner surface spaced from an outer surface and a plurality of chord members that extend between the inner surface and the outer surface. The clamp body may include a clamp member that extends through the bottom arm and a clamp head where the clamp translates between the top arm in a closed position and the bottom arm in an open position. The strap may include first and second ends, the strap may be moveable relative to the tie down mechanism.

In one embodiment, provided is a tie down attachment device that includes a ratchet mechanism, a strap received in the ratchet mechanism, the strap selectively positionable out of and into the ratchet mechanism, an arm movably attached to the ratchet mechanism securing the strap relative to the ratchet mechanism, and a clamp body attached to the ratchet mechanism, the clamp body having a generally C-shape. The tie down attachment device may also include a clamp member extending through the clamp body the clamp member translating between a top portion of the clamp body in a closed position and away from the top portion in an open position, where the clamp member in the closed position engages a rail of a vehicle.

The clamp member may translate by rotation of the clamp member. The clamp member may include a grasping portion to rotate the clamp member. The clamp body may include a plurality of cord members and a plurality of general hollow portions. The tie down attachment device may also include a pad positioned on the top portion of the clamp body.

In embodiments, a tie down attachment device may include a ratchet mechanism, a strap received in the ratchet mechanism, the strap selectively positionable out of and into the ratchet mechanism, a clamp body attached to the ratchet mechanism, the clamp body having a generally C-shape, and a clamp member extending through the clamp body. The ratchet mechanism may be attached to an upper surface of the clamp body. The clamp member may translate between a top portion of the clamp body in a closed position and away from the top portion in an open position, where the clamp member in the closed position engages a rail of a vehicle. A pad may be positioned on the top portion of the clamp body. The pad may be of an elastomeric material and may protect a surface of the rail of the vehicle.

### BRIEF DESCRIPTION OF THE DRAWINGS

Objects and advantages together with the operation of the present teachings may be better understood by reference to the detailed description taken in connection with the following illustrations, wherein:

FIG. 1 is a perspective view of embodiments of a rail tie down device in accordance with the present disclosure;

FIG. 2 is a front perspective view of embodiments of a rail tie down device in accordance with the present disclosure;

FIG. 3 is a side view of the rail tie down device in accordance with the present disclosure;

FIG. 4 is a perspective view of the rail tie down device in accordance with the present disclosure;

FIG. 5 is an exploded view of the rail tie down device of FIG. 4 in accordance with the present disclosure;

FIG. 6 is a top perspective view of a clamp body of the rail tie down device in accordance with the present disclosure;

FIG. 7 is a bottom perspective view of the clamp body of the rail tie down device in accordance with the present disclosure;

FIG. 8 is an enlarged view of a top of the clamp body of the rail tie down device in accordance with the present disclosure;

FIG. 9 is a side view of the clamp body of the rail tie down device in accordance with the present disclosure;

FIG. 10 is a perspective view of the clamp body of the rail tie down device in accordance with the present disclosure;

FIG. 11 is a perspective view of embodiments of the rail tie down device in accordance with the present disclosure;

FIG. 12 is a perspective view of embodiments of the rail tie down device in accordance with the present disclosure; and

FIG. 13 is a front perspective view of embodiments of a rail tie down device secured to a rail of a vehicle in accordance with the present disclosure.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments, not necessarily including all aspects described herein, etc.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

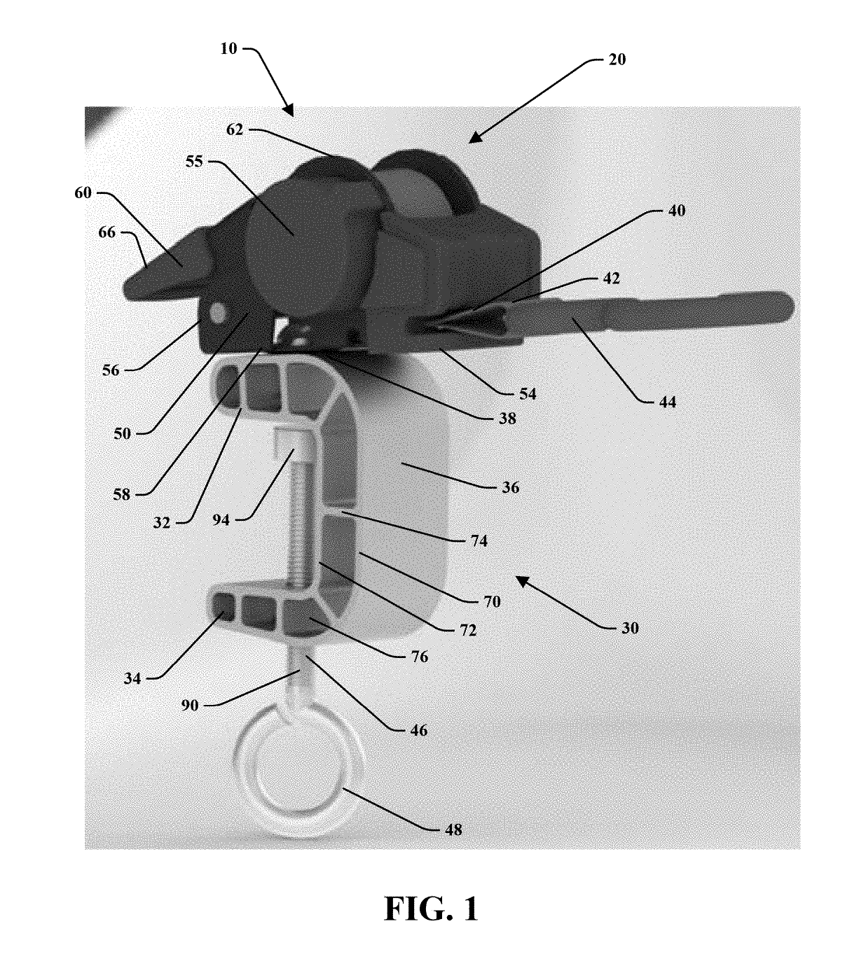

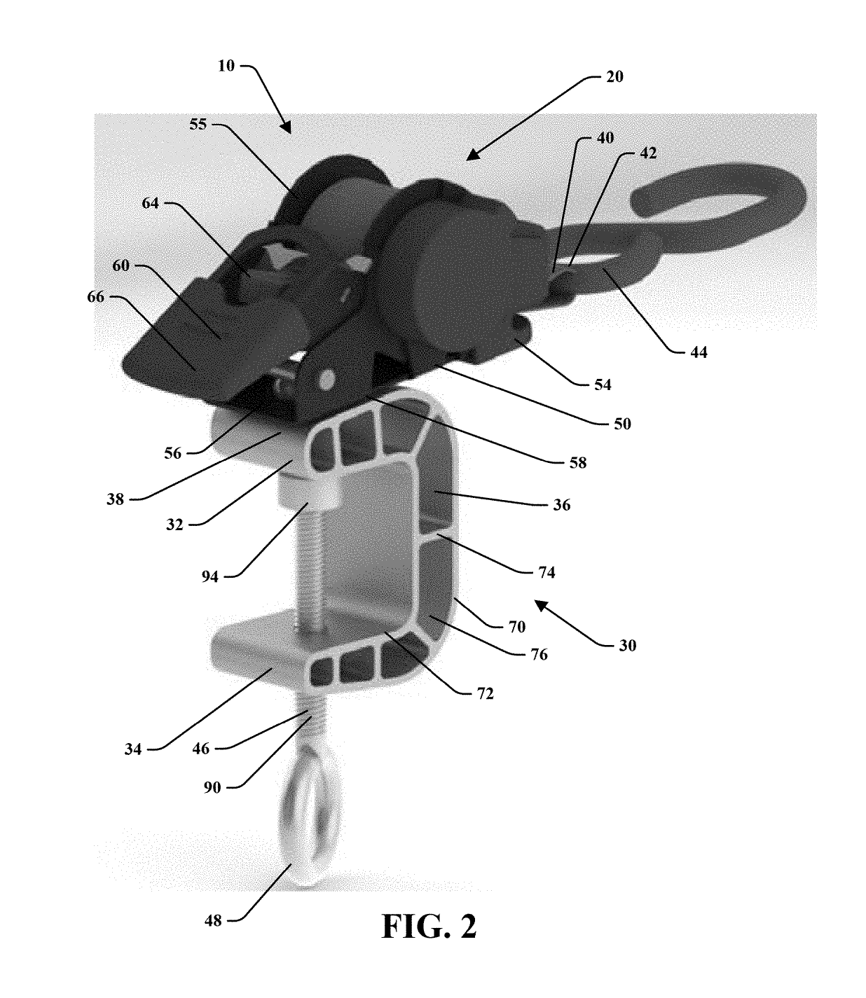

A tie down attachment device 10 is illustrated in FIGS. 1-5. The tie down attachment device 10 may secure cargo in any appropriate manner. By way of a non-limiting example, the tie down attachment device 10 may secure cargo in a bed of a vehicle, in a storage area, or otherwise within any portion of a vehicle. The tie down attachment device 10 may be fixed to one position to the vehicle and may secure directly to cargo and/or to a second portion of a vehicle. The fixed end of the tie down attachment device 10 may be moveable with respect to the vehicle in either a plurality of fixed positions or in an infinite number of positions between two end locations.

The tie down attachment device 10 may include a tie down mechanism 20 and a clamp body 30. The tie down mechanism 20 may be configured as a ratchet—the ratchet may be of any appropriate type and configuration and is not limited to just that shown and described herein. Any type of ratchet may be utilized with the present teachings. The tie down mechanism 20 may include a strap 40 that may be elongated and formed of any appropriate material. In some embodiments, the strap 40 may be elastic and generally stretchable and in other embodiments, the strap may not be stretchable. By way of a non-limiting example, the strap 40 may include one or more strands that form material that is made of at least one of nylon, cotton, polypropylene, carbon fiber, nylon rope, plastic, polymer or other such stretchable or non-stretchable materials or any combination of each such enumerated materials or materials otherwise described.

The tie down mechanism 20 may include a main body portion 50 that includes a centralized component such as a housing 55 for mounting a reel (not shown) and a lever arm 60. The strap 40 may be wound about the reel of the housing 55 and the strap 40 may extend a selected distance from the tie-down attachment device 10 as needed for attachment to various objects, support surfaces, etc. Different embodiments of the tie down attachment device 10 may have a strap of various configuration, length and width. The main body portion 50 may include a first end 54 and an opposite second end 56. The body portion 50 may also include a base 58 that may extend between the first end 54 and the second end 56. The base 58 may be attached to the clamp body 30 in any appropriate manner.

The strap 40 may include two ends, a first end 42 being extendable from the first end 54 of the main body portion 50 and the opposite second end (not shown) being attachable to the reel of the housing 55 or extendable through the housing 55. The distance between the first end 42 and second end may be of any appropriate measurement. A fastener 44 may be selectively attached to the first end 42 of the strap 40. The fastener 44 may be of any configuration, including, without limitation, it may be a loop with a hook or other type of fastener that may assist with attaching the strap 40. The fastener 44 may be selectively or fixedly attached with the strap 40. Depending on the use of the tie down attachment device 10, any appropriate distance may be utilized. Moreover, the tie down attachment device 10 may vary the distance between the first end 42 and second end of the strap 40 as described in more detail below.

The strap 40 may be wound on the housing 55 so that it progressively wraps about itself to form a spiral roll. The housing 55 may include a generally round or tubular structure such as a reel to permit the strap to be wound and unwound as desired. Additionally, the housing 55 may include components (not shown) that may be configured to grasp a portion of the strap 40 such as the second end. Further, sidewalls 62 may extend from the housing 55 to assist with guiding and retaining the strap 40 about the reel to provide alignment for consistent winding and unwinding of the strap 40 relative to the reel. The housing 55 may include a biasing member such that the housing 55 may be a spring loaded wherein the reel may be configured to retract the strap 40 automatically when a lock member 64 is depressed.

By way of a non-limiting example, the housing 55 may include a hub or reel having a slot that extends through a center section of the hub. The center section may further include a generally concave recess that may be cutout from or integrally formed with it. The recess may be generally shaped and sized to receive a pin on which the strap 40 may connect. In particular, the strap 40 may include a sewn loop or any other appropriate fastening device, at an end of the strap 40. The pin may be shaped and sized to fit within the sewn loop of the strap 40. The pin and sewn loop of the strap 40 may generally fit within the recess such that during operation of the tie down attachment device 10, the strap 40 may generally concentrically wrap around the center section of the hub such that there are no “bumps.” In some embodiments, the pin—and in some embodiments the sewn loop portion of the strap 40—may fit within recess such that a portion of the exterior surface of the pin—or the sewn loop portion of the strap 40—may generally be an extension of the exterior surface of the hub as the exterior surfaces extend circumferentially around a central axis of hub. These configurations may generally eliminate the eccentric rotation of the strap 40 that may otherwise occur with prior art systems.

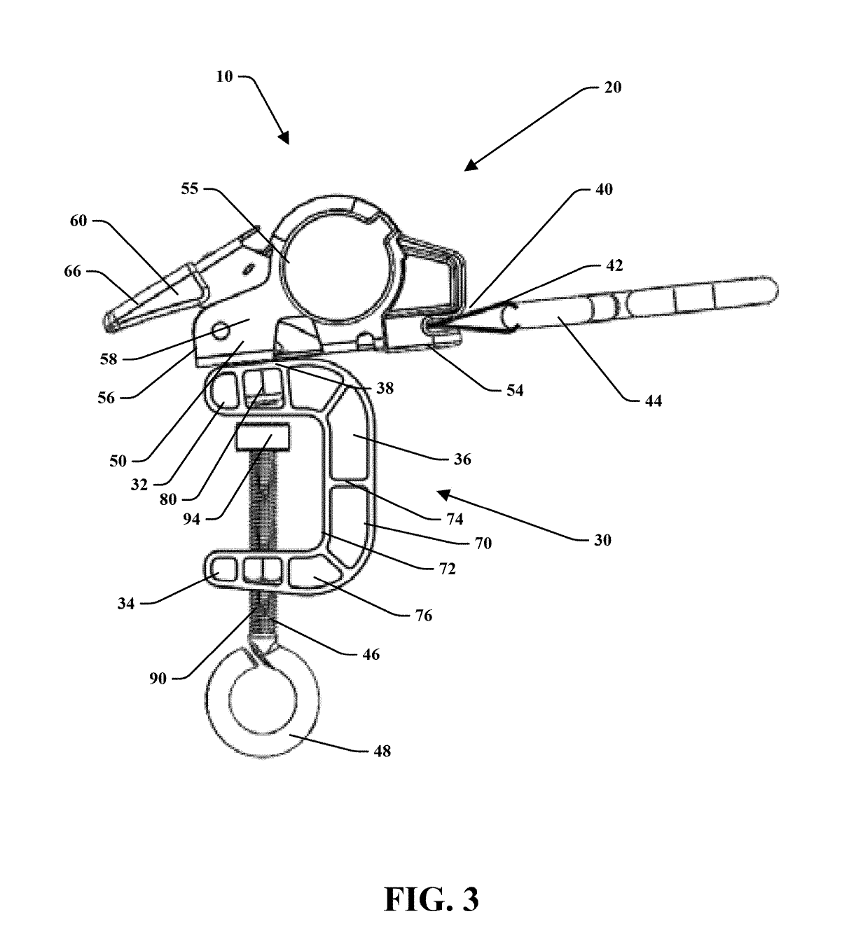

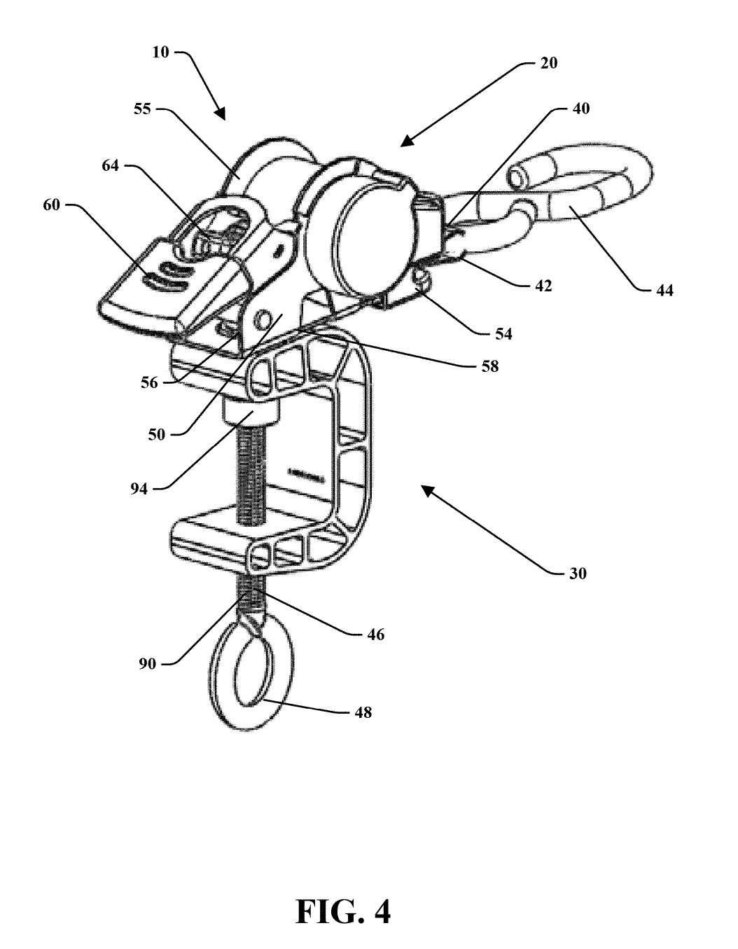

The lever arm 60 may be attached to the main body portion 50 of the ratchet 20 and may extend from the second end 56. The lever arm 60 may be rotatably attached to the main body portion 50 and/or various associated components, to drive the rotation of the housing 55. As illustrated by FIGS. 3 and 4, the lock member 64 may be attached to the lever arm 60. The lever arm 60 may be rotatable along an arc relative to the main body portion 50 and may be rotatable between various positions. The lever arm 60 may also include a grasp surface 66 for a user to easily grasp and rotate the arm 60. The lock member 64 may be positioned to allow a user to press the lock member 64 to selectively engage or disengage the lock member 64 from components of the housing 55 to selectively rotate the reel/hub to wind and unwind the strap 40.

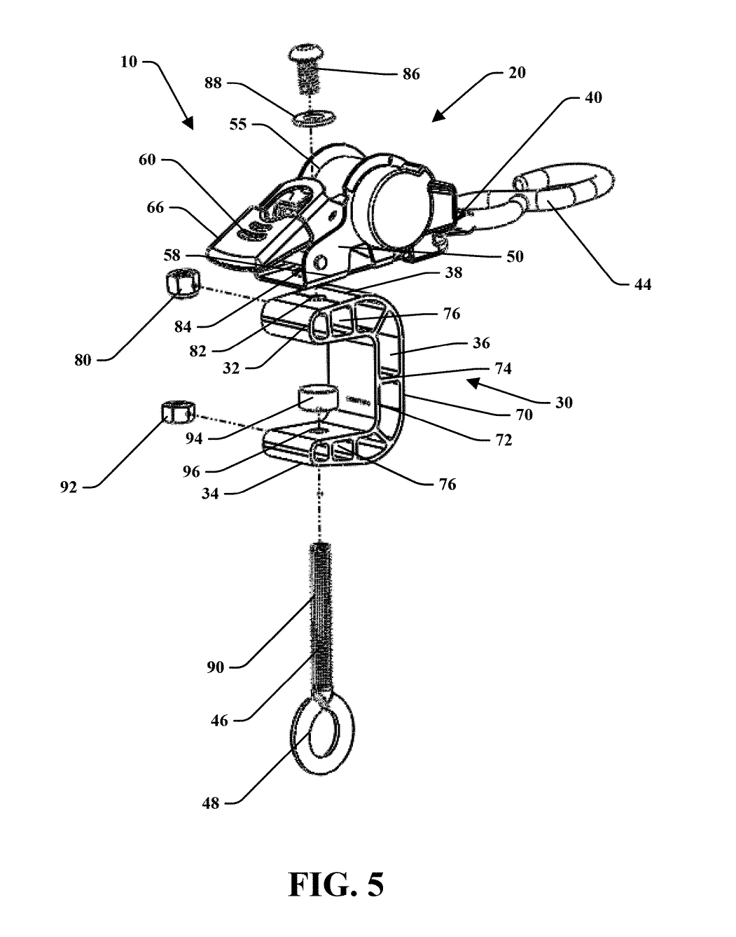

The clamp body 30 may be attached to the tie down mechanism 20 in any appropriate manner. The clamp body 30 may be configured to structurally and operatively support the tie down mechanism 20 on a rail 100 of a truck bed. The clamp body 30 may include a top arm 32, a bottom arm 34, and a base 36. The top arm 32, bottom arm 34, and base 36 may be formed from a monolithic piece of material that may be formed into a general C-shape, but this disclosure is not limited to such configuration. The clamp body 30 may be formed such as through subsequent engagement processes, e.g., welding, fastening or adhering. As illustrated by FIG. 5, the top arm 32 may include a top surface 38 that may abut against an underside of the base 58 of the main body portion 50 of the tie down mechanism 20. The top arm 32 may include an aperture 82 and the base 58 of the main body portion 50 may include an aperture 84 to allow a fastener 86 to extend through both apertures 82 and 84 to support the attachment of the tie down mechanism 20 to the top arm 32 of the clamp body 30. This may result in the tie down mechanism 20 being selectively attached to the clamp body 30. In the alternative, the tie down mechanism 20 may be fixedly attached to the clamp body 30 by welding, adhering, forming monolithically or fastening.

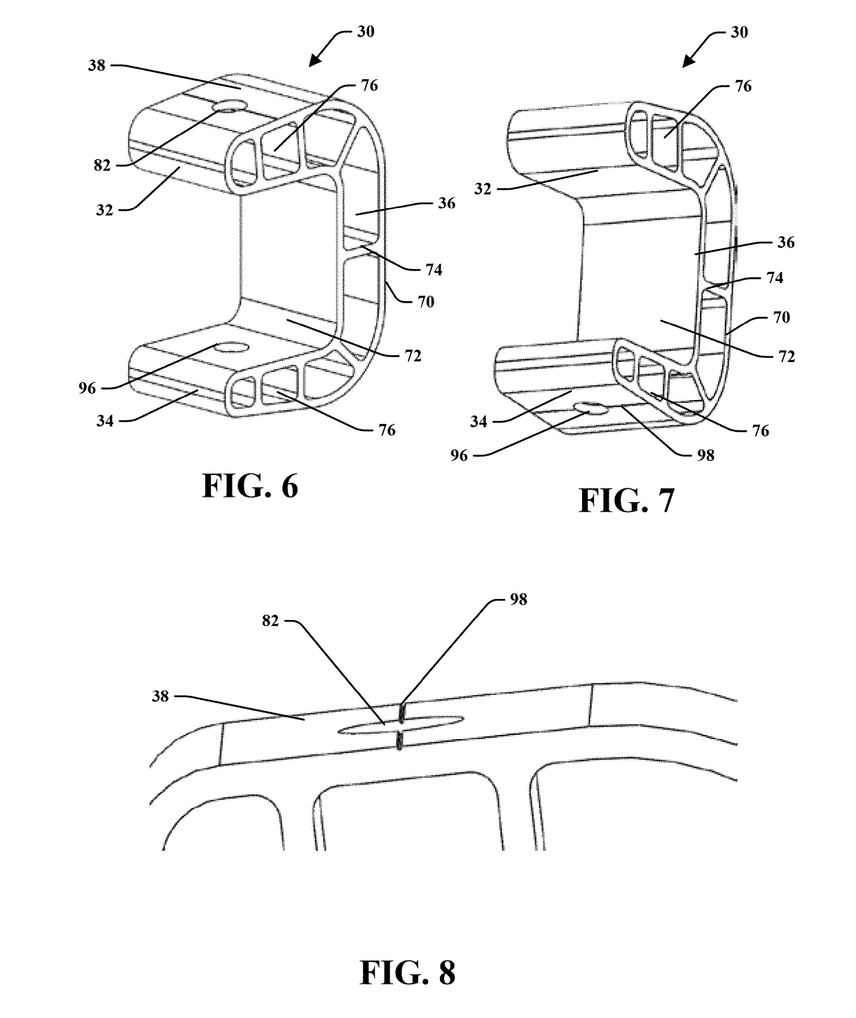

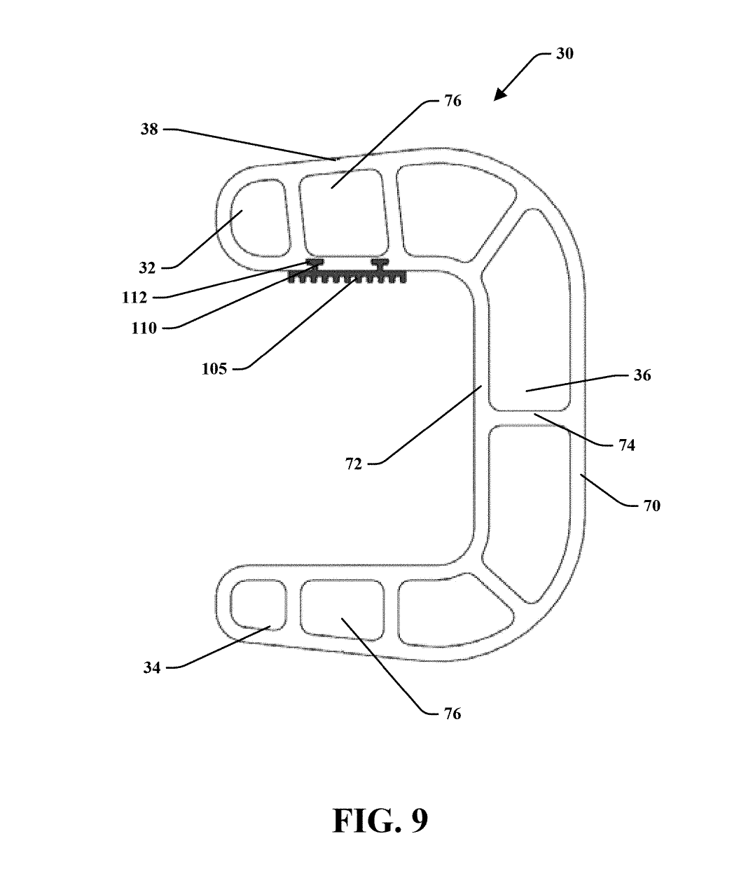

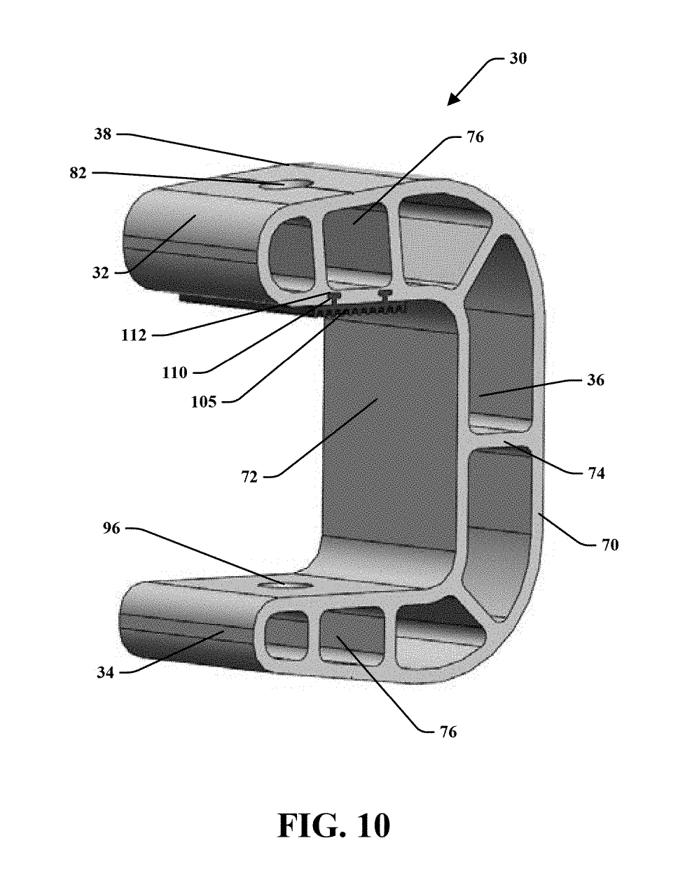

As illustrated by FIGS. 5-10, the clamp body 30 may be an extruded rigid material such as a metal or alloy. In one embodiment, the clamp body 30 may be made of an extruded aluminum. The clamp body 30 may include an outer surface 70 and an inner surface 72 spaced from one another. The outer surface 70 and inner surface 72 may come together at ends of the top arm 32 and bottom arm 34. A plurality of cord members 74 may extend between the inner surface 70 and outer surface 72 to provide structural strength to the clamp body 30. The cord members 74 may be spaced apart from one another by a plurality of hollow portions 76 or openings. This configuration may reduce the overall weight of the clamp body 30 while maintaining its strength. The plurality of openings 76 may be located between each of the chord members 74 such that the aperture 82 positioned on the top arm 32 may be generally aligned with an opening 76 between chord members 74. A fastener member 80 such as a lock nut maybe positioned within this opening 76 to attach to the fastener 86 that extends through apertures 82 and 84—which may be selectively or fixedly attached. Additionally, a washer 88 may be provided between fastener member 80 and fastener 86. This configuration supports the attachment between the clamp body 30 and the tie down mechanism 20.

In one embodiment, the base 58 of the body portion 50 may be aligned with the clamp body 30 such that the first end 54 is aligned with the base 36 of the clamp body 30 and the second end 56 is aligned with ends of the top arm 32 and the bottom arm 34. This configuration allows the strap 40 to extend from the body portion 50 positioned over the base 35 of the clamp body 30. Optionally, the base of the body portion 50 may be rotatable relative to the clamp body 30 such that the strap 40 may extend from the body portion 50 at any relative portion from the clamp body 30.

Additionally, an aperture 96 may be positioned along the bottom arm 34 such that one of the plurality of openings 76 may be located between each of the chord members 74 and extend between the inner surface 72 and outer surface 74. The aperture 96 positioned on the bottom arm 34 may be generally aligned with an opening 76 between chord members 74. A clamp member 90 such as a threaded shaft 46 with an eyehole 48 may be received within this aperture 96 through the bottom arm 34 to be rotatably attached to fastener member 92 within the opening 76. The clamp member 90 may be attached to a clamp head 94 positioned between the top arm 32 and bottom arm 34 and may translate between the top arm 32 in a closed position and the bottom arm 34 in an open position. The clamp member 90 may be threadingly attached to the fastener member 92 within the bottom arm 34 and extend through aperture 96. The clamp member 90 may have various embodiments and is not limited to an eyehole as it may also include a pin, handle or other device configured to be grasped by a user and selectively rotated to translate the clamp head 94 against a rail 100 of a truck bed. The user may position the clamp head 94 such that the rail 100 is positioned between the clamp head 94 and top arm 32. The user may then tighten the clamp member 90 to engage the rail 100 and operatively position the tie down attachment device 10.

As illustrated in FIGS. 7 and 8, a small channel 98 may extend along a width of the top arm 32 and bottom arm 34. This may allow a user to properly align or locate a center of aperture 82, 96 for drilling between chords 76. Further, as illustrated by FIG. 7, the aperture 82 may not pass through the inner surface 72 along the top arm 32 (although it may in other embodiments).

In another embodiment, a pad 105 may be attached to the inner surface 72 along the top arm 32. The pad 105 may be made of an elastomeric material, including, without limitation, rubber, polymer, such as EPDM rubber. The pad 105 may be generally aligned with the position of the clamp head 94. The pad 105 may be configured with at least one protrusion 110 that may be inserted into complimentary shaped portions 112 within the inner surface 72 of the top arm 32, such as to snap-fit onto the inner surface 72. In one embodiment, the protrusions 110 may have a T-shaped orientation that may extend along a width of the pad 105. Although, the present teachings are not limited to this configuration. The protrusions 110 may be of any appropriate shape and configuration and may fit within corresponding openings with the inner surface 72 of the top arm 32. The protrusions 110 may engage such as through a snap-fit, friction fit or a fastener may be utilized. Alternatively, the pad 105 may be adhered to the inner surface 72 or welded thereto. The pad 105 may be configured to provide support as the clamp body 30 is attached to the rail 100 and further assist to frictionally prevent unwanted twisting or other movement of the tie down attachment device 10 as it is attached to the rail 100. The pad 105 may also prevent scratches from occurring along the surface of the rail 100. Optionally, the pad 105 may extend along any portion of the inner surface 72 along the top arm 32, base 36, or bottom arm 34.

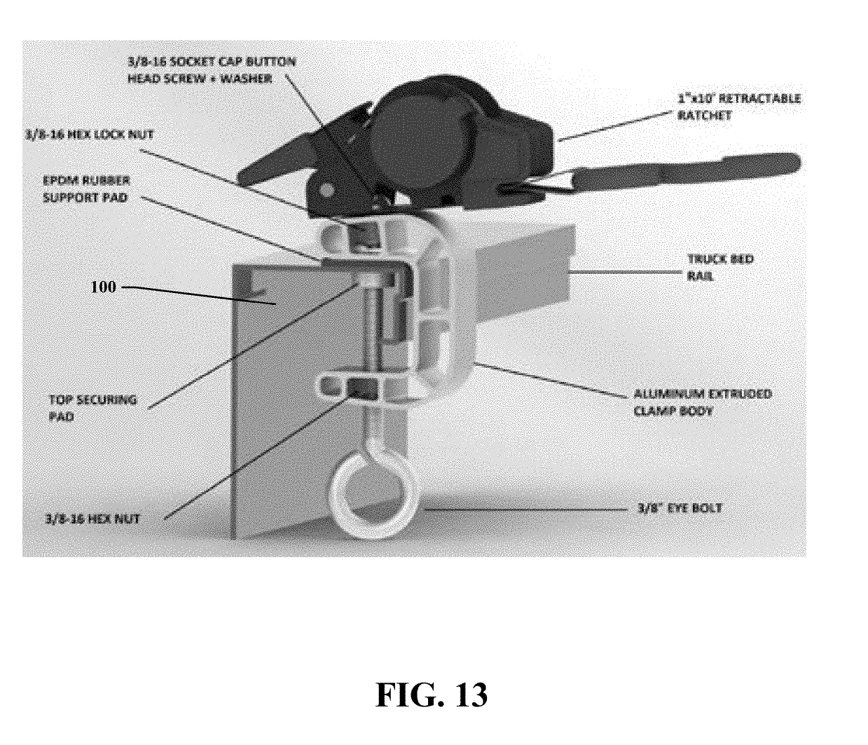

The clamp member 30 may attach to a truck bed rail 100 as illustrated by FIG. 13. The truck bed rail 100 may be positioned along the inner surface 72 and particularly rest against the top arm 32. The clamp member 90 may be rotated to translate the clamp head 94 towards the top arm 32 to clamp against an undersurface of the rail 100 to clamp the rail 100 against the inner surface 72 along the top arm 32. The outer surface of the rail 100 may abut against the pad 105. This configuration supports the attachment between the clamp body 30 and the truck bed rail 100.

The clamp body 30 may be particularly designed for the forces associated with clamping against a truck bed rail 100. In particular, the clamp body 30 may be made of aluminum having openings 76 defined by a plurality of chords 74 arranged between the inner surface 72 and outer surface 70 to provide a predetermined amount of support. The arrangement of the chords 74 may provide a lightweight webbing support member configured to be sufficient in supporting stresses acting longitudinally and transverse from the clamp body 30 connection point to the rail 100. In one embodiment, the clamp body 30 may be made of 6061, T6 extruded aluminum.

Additional embodiments of a tie down attachment device 10 according the present teachings are described below. In the descriptions, all of the details and components may not be fully described or shown. Rather, the features or components are described and, in some instances, differences with the above-described embodiments may be pointed out. Moreover, it should be appreciated that these additional embodiments may include elements or components utilized in the above-described embodiments although not shown or described. Thus, the descriptions of these additional embodiments are merely exemplary and not all-inclusive nor exclusive. Moreover, it should be appreciated that the features, components, elements and functionalities of the various embodiments may be combined or altered to achieve a desired adjustable length cargo strap without departing from the spirit and scope of the present teachings.

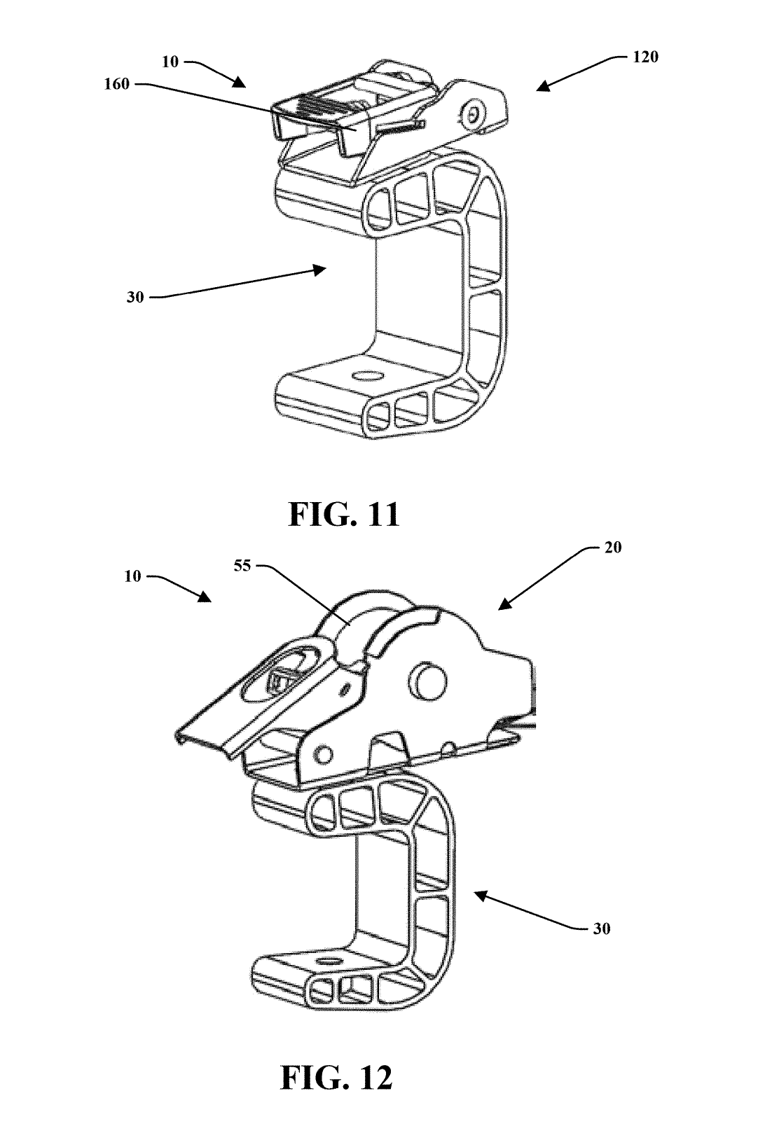

In some embodiments, such as that shown in FIGS. 11, tie down attachment device 10 may include a tie-down mechanism that is a cam buckle 120 attached to the clamp body 30. The cam buckle may operate by receiving the strap 40 therein and having a user manually pull the strap 40 a desired amount to tighten or loosen the strap. The cam buckle may include a lock arm 160 that can selectively engage the strap 40 to maintain the strap 40 in a desired position or free the strap 40 for movement as needed relative to the tie down attachment device 10. Additionally, the cam buckle tie-down mechanism 120 may not include a housing or reel as it relies on the user to tension and loosen the strap 40 relative to the attachment device 10. Alternatively, the tie down attachment device 10 may include a housing as illustrated by FIG. 12.

Still further, in some embodiments the tie down attachment device 10 may be used in other environments where it is desired to tighten a cable, rope, webbing or the like, such as, e.g., tightening a tent rope, a guy wire, a sailing line and so on.

What has been described above includes examples of the present teachings. It is, of course, not possible to describe every conceivable combination of components or methodologies for purposes of describing the present teachings, but one of ordinary skill in the art may recognize that many further combinations and permutations of the present teachings are possible. Furthermore, it is noted that the various embodiments may be altered, combined, or arranged in any desired configuration. For instance, different locking members or components thereof may be combined and utilized in different combinations than illustrated. Accordingly, the present teachings are intended to embrace all such alterations, modifications and variations that fall within the spirit and scope of the appended claims. To the extent that the term “includes” is used in either the detailed description or the claims, such term is intended to be inclusive in a manner similar to the term “comprising” as “comprising” is interpreted when employed as a transitional word in a claim.

Having thus described the invention, the following is claimed:

1. A tie down attachment device comprising:
a tie down mechanism;
a strap received in the tie down mechanism;
an arm movably attached to the tie down mechanism securing the strap relative to the tie down mechanism; and
a clamp body attached to the tie down mechanism, the clamp body with a configuration to selectively and operatively engage a rail of a load bed of a vehicle.

2. The tie down attachment device of claim 1, wherein the tie down mechanism comprises a ratchet.

3. The tie down attachment device of claim 2, wherein the ratchet comprises a housing wherein the strap is wound and unwound from the housing.

4. The tie down attachment device of claim 3, wherein the arm includes a locking member selectively engaged to at least one of the housing and the strap to prevent the strap from moving away from the housing.

5. The tie down attachment device of claim 2, wherein the ratchet includes a main body portion having a first end and an opposite second end and a base that extends between the first end and the second end wherein the base is attached to the clamp body.

6. The tie down attachment device of claim 1, wherein the tie down mechanism is a cam buckle wherein the strap is manually moved relative to the tie down mechanism.

7. The tie down attachment device of claim 1, wherein the clamp body includes a top arm, a bottom arm, and a base formed into a general C-shape.

8. The tie down attachment device of claim 1, wherein the clamp body is formed of a monolithic piece of material.

9. The tie down attachment device of claim 8, wherein the clamp body includes an inner surface spaced from an outer surface and a plurality of chord members that extend between the inner surface and the outer surface.

10. The tie down attachment device of claim 7, wherein the clamp body includes a clamp member that extends through the bottom arm and a clamp head wherein the clamp translates between the top arm in a closed position and the bottom arm in an open position.

11. The tie down attachment device of claim 1, wherein the strap includes first and second ends, the strap moveable relative to the tie down mechanism.

12. A tie down attachment device comprising:
a ratchet mechanism;
a strap received in the ratchet mechanism, the strap selectively positionable out of and into the ratchet mechanism;
an arm movably attached to the ratchet mechanism securing the strap relative to the ratchet mechanism;
a clamp body attached to the ratchet mechanism, the clamp body having a generally C-shape; and
a clamp member extending through the clamp body the clamp member translating between a top portion of the clamp body in a closed position and away from the top portion in an open position, wherein the clamp member in the closed position engages a rail of a vehicle.

13. The tie down attachment device of claim 12, wherein the clamp member translates by rotation of the clamp member.

14. The tie down attachment device of claim 13, wherein the clamp member includes a grasping portion to rotate the clamp member.

15. The tie down attachment device of claim 13, wherein the clamp body includes a plurality of cord members and a plurality of general hollow portions.

16. The tie down attachment device of claim 12 further comprising a pad positioned on the top portion of the clamp body.

17. A tie down attachment device comprising:
a ratchet mechanism;
a strap received in the ratchet mechanism, the strap selectively positionable out of and into the ratchet mechanism;
a clamp body attached to the ratchet mechanism, the clamp body having a generally C-shape;
a clamp member extending through the clamp body the clamp member translating between a top portion of the clamp body in a closed position and away from the top portion in an open position, wherein the clamp member in the closed position engages a rail of a vehicle; and
a pad positioned on the top portion of the clamp body.

18. The tie down attachment device of claim 17, wherein the ratchet mechanism is attached to an upper surface of the clamp body.

19. The tie down attachment device of claim 17, wherein the pad comprises an elastomeric material.

20. The tie down attachment device of claim 19, wherein the pad protects a surface of the rail of the vehicle.
